(19) United States
(12) Patent Application Publication
(10) Pub. No.: US 2025/0106605 A1
(43) Pub. Date: Mar. 27, 2025

(54) Coordination of Wireless Sensing with Multiple Network Nodes

(71) Applicant: ZTE Corporation, Shenzhen (CN)

(72) Inventors: Li YANG, Shenzhen (CN); Zhiqiang HAN, Shenzhen (CN); Shuqiang XIA, Shenzhen (CN); Feng XIE, Shenzhen (CN)

(73) Assignee: ZTE Corporation, Shenzhen (CN)

(21) Appl. No.: 18/970,282

(22) Filed: Dec. 5, 2024

Related U.S. Application Data
(63) Continuation of application No. PCT/CN2022/104719, filed on Jul. 8, 2022.

(51) Int. Cl. H04W 4/38; H04W 64/00

(52) U.S. Cl. CPC H04W 4/38; H04W 64/00

(57) ABSTRACT

Management and coordination of sensing may be performed through a wireless sensing session management function (S-SMF) that provides policies, configuration data, or sensing assistant data related to a wireless sensing session. S-SMF may be in independent and decoupled from a session management function (SMF), which provides communication session related policies and configuration data. The S-SMF manages the wireless sensing session and the SMF manages other communication sessions. Additional functions may include a Sensing Anchor Function (AMF) configured for controlling a wireless sensing session, and a Sensing Data Storage Function (S-UPF) configured for storing wireless sensing result data from the wireless sensing session.

### TECHNICAL FIELD

This document is directed generally to wireless sensing. More specifically, management and coordination of wireless sensing can be improved for systems with multiple network nodes.

### BACKGROUND

Wireless communication technologies are moving the world toward an increasingly connected and networked society. Wireless communications rely on efficient network resource management and allocation between user mobile stations and wireless access network nodes (including but not limited to radio access network (“RAN”) nodes and wireless basestations). A new generation network is expected to provide high speed, low latency and ultra-reliable communication capabilities and fulfil the requirements from different industries and users. User mobile stations or user equipment (“UE”) are becoming more complex and the amount of data communicated continually increases. With the development of more advanced radar and sensing systems, communications between with the UE can be modernized.

### SUMMARY

This document relates to methods, systems, and devices for the management and coordination of wireless sensing can be improved for systems with multiple network nodes. Management and coordination of wireless sensing may be performed through a wireless sensing session management function (S-SMF) that provides policies, configuration data, or sensing assistant data related to a wireless sensing session. S-SMF may be independent and decoupled from a session management function (SMF) for communication purpose, which provides communication session related policies and configuration data. The S-SMF manages the wireless sensing session and the SMF manages other communication sessions. Additional functions may include a Sensing Anchor Function (AMF) configured for controlling a wireless sensing session, and a Sensing Data Storage Function (S-UPF) configured for storing wireless sensing result data from the wireless sensing session.

In one embodiment, a method for wireless sensing includes triggering a wireless sensing session for a sensing purpose(s); coordinating via signaling procedure(s); and managing operation of the wireless sensing session based on the coordinating. The triggering, coordinating and managing are conducted by a Core Network Sensing Session Management Function (S-SMF). The triggering is triggered independently by the S-SMF or upon receiving a command for “Sensing Service Required” from another node or entity. The coordinating is with a Core Network Sensing Anchor Function (AMF), which includes a wireless sensing context(s), and the coordinating is with a Core Network Sensing Data Storage Function (S-UPF), which includes the wireless sensing session result data. The method includes selecting a target Core Network Sensing Anchor Function before the triggering. The method includes triggering a retrieval of wireless sensing session result data. The retrieval is conducted by the Core Network S-SMF independently or upon receiving the a “Sensing Result Data Retrieval Request” command from another node or entity. The wireless sensing session result data comprises a sensing result data associated with the wireless sensing session performed by a basestation and/or a user equipment (UE). The method includes storing the wireless sensing session result data by a Core Network Sensing Data Storage Function” entity (S-UPF). The wireless sensing session comprises different wireless sensing types, at least including a target positioning determination, a radio channel estimation, an environment imaging or object detection based on radar type sensing, and/or biological indicators. The wireless sensing session comprises functions performed by local wireless sensors in a basestation and/or a user equipment (UE).

In another embodiment, a wireless communications apparatus includes a processor and a memory, wherein the processor is configured to read code from the memory and implement any method recited herein.

In another embodiment, a computer program product includes a computer-readable program medium code stored thereupon, the code, when executed by a processor, causing the processor to implement any method recited herein.

In another embodiment, a system includes a wireless sensing session management function (S-SMF) for providing policies, configuration data, or sensing assistant data related to a wireless sensing session; and a session management function (SMF) for providing communication session related policies and configuration data, wherein the S-SMF is independent and decoupled from the SMF. The system further includes a user equipment (UE); and a basestation between the UE and the Access and Mobility Management Function (AMF), the S-SMF, or the SMF. The basestation generates wireless sensing signals subject to policies, configuration data, or sensing assistant data provided by S-SMF, wherein the wireless sensing signals are for the UE, a target entity, or environment. The S-SMF manages the wireless sensing session and the SMF manages other communication session(s). The managing of the wireless sensing session includes a retrieval of wireless sensing session result data. The retrieval is performed independently or upon receiving a “Sensing Result Data Retrieval Request” command from another node or entity. The sensing session result data includes data associated with the wireless sensing session performed by the basestation and/or the UE. The wireless sensing session comprises different wireless sensing types, at least including a target positioning determination, a radio channel estimation, an environment imaging or object detection based on a radar-type sensing, and/or biological indicators.

In another embodiment, a system includes a Sensing Anchor Function (AMF) configured for controlling a wireless sensing session; a Sensing Session Management Function (S-SMF) configured for managing the wireless sensing session; and a Sensing Data Storage Function (S-UPF) configured for storing wireless sensing result data from the wireless sensing session. The managing further includes providing a wireless sensing session relevant policy; providing a wireless sensing session relevant configuration data and/or assistant data; and circulating the wireless sensing session result data with another node or entity. The wireless sensing session result data is reported by a basestation, a user equipment (UE), and/or is circulated from the S-UPF. The Sensing Session Management Function (S-SMF) includes a centralized management point in the system. The Sensing Management Function comprises a Sensing Session Management Function (S-SMF) for a sensing rather than communication purpose. The sensing result data comprises sensing result data associated with the wireless sensing session performed by a basestation and/or a user equipment (UE). The wireless sensing session comprises different wireless sensing types, at least including a target positioning determination, a radio channel estimation, an environment imaging or object detection based on radar-type sensing, and/or biological indicators.

In one embodiment, a wireless communications apparatus comprises a processor and a memory, and the processor is configured to read code from the memory and implement any of the embodiments discussed above.

In one embodiment, a computer program product comprises a computer-readable program medium code stored thereupon, the code, when executed by a processor, causes the processor to implement any of the embodiments discussed above.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example basestation.

FIG. 2 shows an example random access (RA) messaging environment.

FIG. 3 shows a single connectivity wireless communication system.

FIG. 4 shows a dual connectivity wireless communication system.

FIG. 5 shows a dual function radio access network (“RAN”) node that communicates with user equipment (“UE”) through the dual functional links.

FIG. 6 shows a communication diagram with a dual function RAN node communication with a communication radio link (“C-RL”) and a sensing radio link (“S-RL”).

FIG. 7 shows an embodiment of a wireless network system architecture.

FIG. 8 shows an example architecture for an end to end (E2E) wireless sensing operation.

FIG. 9 shows an embodiment of a network system for sensing between multiple network nodes.

FIG. 10 shows an embodiment of sensing communications between multiple network nodes.

FIG. 11 shows another embodiment of a network system for sensing between multiple network nodes.

FIG. 12 shows another embodiment of sensing communications between multiple network nodes.

FIG. 13 shows a wireless sensing example with user equipment (UE) positioning.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

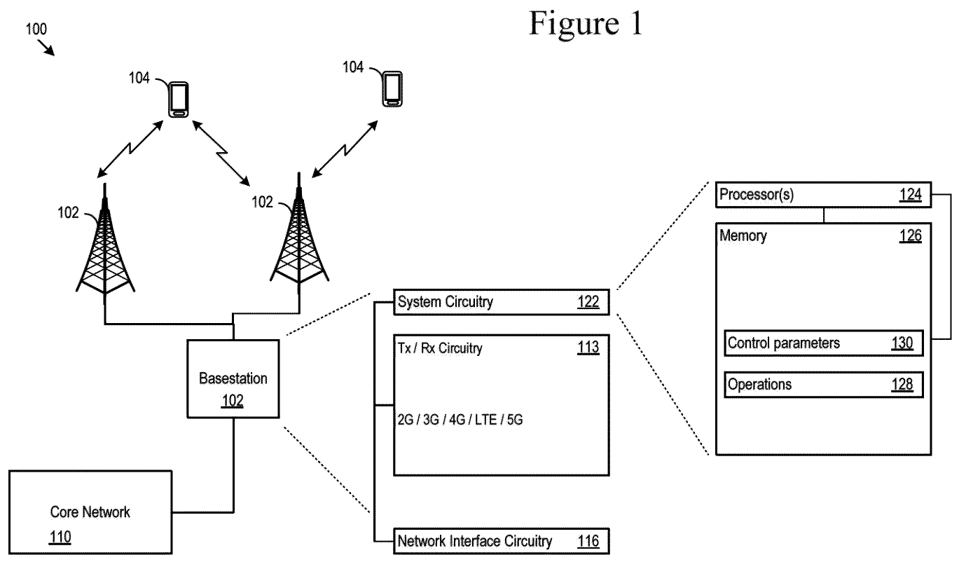

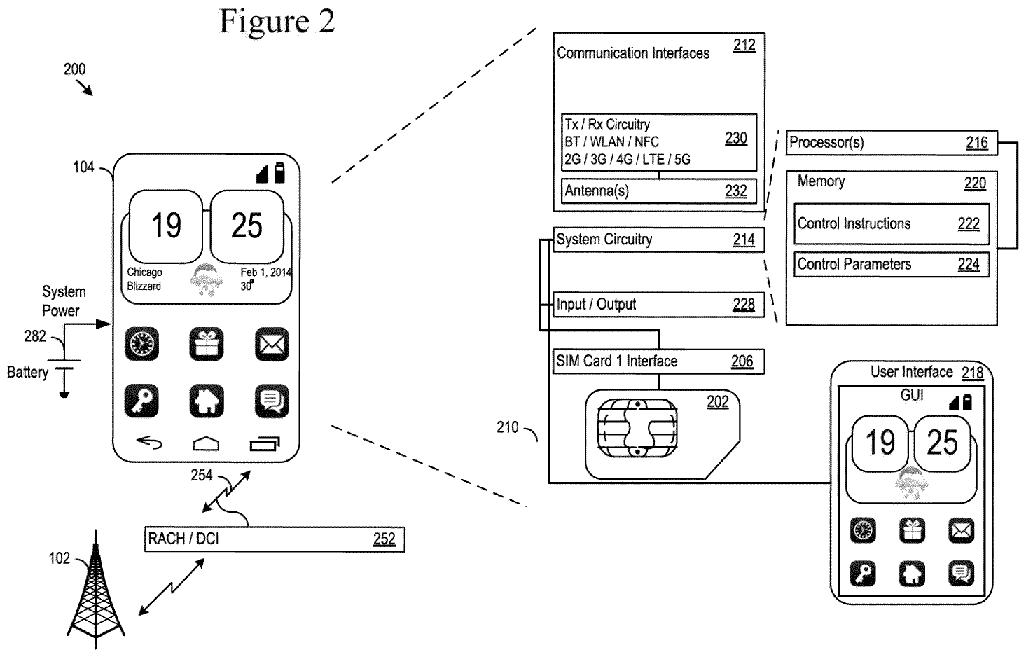

Radio resource control (“RRC”) is a protocol layer between UE and the basestation at the IP level (Radio Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). UE can transmit infrequent (periodic and/or non-periodic) data in RRC_INACTIVE state without moving to an RRC_CONNECTED state. This can save the UE power consumption and signaling overhead. This can be through a Random Access Channel (“RACH”) protocol scheme or a Configured Grant (“CG”) scheme. The wireless communications described herein may be through radio access. In addition, the embodiments described include sensing communications or sensing signals, which are either physically different from wireless communications or logically different from wireless communications. FIGS. 1-2 show example radio access network (“RAN”) nodes (e.g. basestations) and user equipment and messaging environments, which may be applicable to both the wireless communications and sensing communications.

In some wireless communication systems (such as 4G-LTE and 5G-NR), the RAN node may transmit downlink pilot reference signals such as SSB, CSI-RS etc., and the UE receives, measures and processes them so that UE knows the connection quality of the communication radio link (“RL”). This may be conducted between a serving RAN node and the UE in order to maintain mobility and service continuity. The “UE based measurement & report” is one example of sensing configured by network. However, there can be more and different measuring & sensing & report examples between the network and the UE. The network and the UE can measure, detect and sense objects other than pilot reference signals for communications. The sensing may allow for the measure, detection and sensing of a UE's local environments and a UE's resource utilization context. Sensing results may be provided to the UE's serving RAN node, so the serving RAN node can know the UE's local environment and resource utilization context, and dynamically improve the connection quality of the communication RL with the UE.

An integrated wireless sensing and communication (ISAC) system may allow for the serving RAN node to sense the human user body or hand gestures actively based on e.g. radar-type sensing techniques. This sensing may be quicker, e.g. 10 ms less latency than other examples (e.g. the legacy UE based measurement report). The serving RAN node can then take more pro-active and quicker actions to boost the connection quality of a radio link (RL). The following are the example RLs and example components described below:
C-RL=communication radio link: the radio link between RAN node and UE, or between RAN nodes, or between UEs, that serve a wireless communication purpose (e.g. transfer data).
S-RL=sensing radio link: the virtual radio link between RAN node and UE, or between RAN node and environment, or between RAN nodes, or between UEs, or between UE and its environment, serving a wireless sensing purpose (e.g. detect and/or sense something).
ISAC RAN node=a RAN node may perform both wireless communication and wireless sensing services. The ISAC RAN node may refer to eNB (4G advanced), gNB (5G advanced) or xNB for future usage (6G+).
ISAC RAN node (C)=a RAN node that may only perform wireless communication service (e.g. legacy RAN node).
ISAC RAN node(S)=a RAN node that may only perform wireless sensing service (e.g. radar-type node).
Sensing Service=an end to end (E2E) operation with a sensing purpose.
Sensing Session=a sensing operation process triggered and executed by a system with multiple network nodes (e.g. an IMT system).
Master ISAC RAN node=the ISAC RAN node playing a master role in a dual connectivity (DC) operation.
Secondary ISAC RAN node=the ISAC RAN node playing a secondary role in DC operation.

With the development of International Mobile Telecommunications (IMT) wireless communication systems (such as 4G-LTE and 5G-NR) and various advanced radar and sensing systems, integration may be difficult in terms of architecture/capability design and network/air interface resource usages, etc. Coming iterations of IMT wireless systems in future may integrate and harmonize various wireless sensing functions with their own communication functions. The radio access network (RAN) node may provide both wireless communication and wireless sensing capabilities and services. The end-to-end (E2E) wireless sensing operation for a sensing service or task may include multiple network nodes (e.g. CN, RAN, and/or UE), which may cause conflicts for triggering and executing a wireless sensing service. As described in the embodiments below, management and coordination of wireless sensing operations with multiple network nodes may be simplified.

In various networks, there may be RAN nodes (e.g. basestations) that can support multiple network types (or multiple generations of network including 4G, 5G, 6G, etc.). Likewise, RAN nodes may support either wireless communication or wireless sensing, or may support both. In order to improve sensing in a network with multiple nodes, there may be an entity for controlling, managing, and/or coordinating the sensing. In one embodiment, a sensing session management function (S-SMF) may be used for sensing between multiple network nodes.

FIG. 1 shows an example (“RAN”) node or basestation 102. The RAN node may also be referred to as a wireless network node. The RAN node 102 may be further identified to as a nodeB (NB, e.g., an eNB or gNB) in a mobile telecommunications context. The example RAN node may include radio Tx/Rx circuitry 113 to receive and transmit with user equipment (UEs) 104. The RAN node may also include network interface circuitry 116 to couple the RAN node to the core network 110, e.g., optical or wireline interconnects, Ethernet, and/or other data transmission mediums/protocols.

The RAN node may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the RAN node. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

FIG. 2 shows an example random access messaging environment 200. In the random access messaging environment a UE 104 may communicate with a RAN node 102 over a random access channel 252. In this example, the UE 104 supports one or more Subscriber Identity Modules (SIMs), such as the SIM1 202. Electrical and physical interface 206 connects SIM1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282.

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

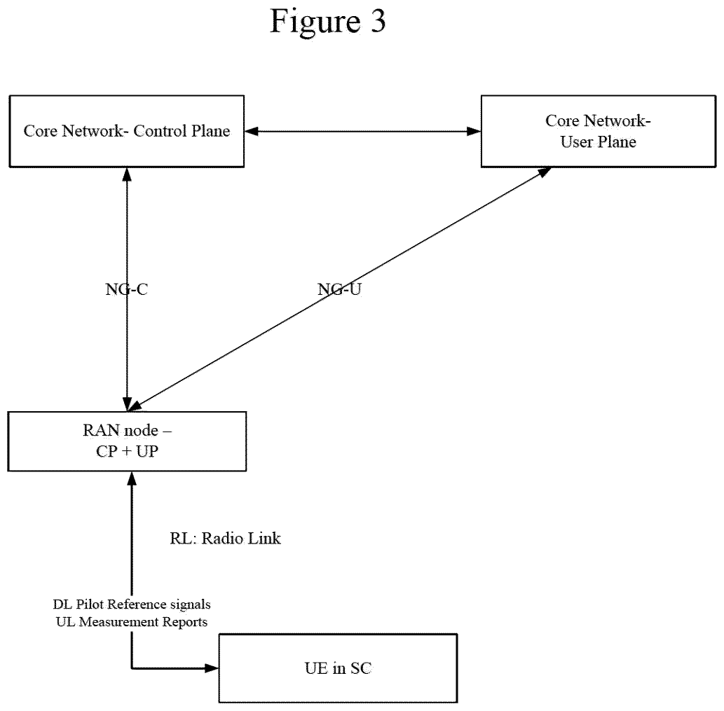

FIG. 3 shows a single connectivity wireless communication system. Single connectivity (SC) may include a UE that only has a master communication radio link (M-C-RL) and/or a master sensing radio link (M-S-RL) but no radio links on the secondary RAN node side. Conversely, dual connectivity (DC) includes a UE with a secondary communication radio link (S-C-RL) and/or a secondary sensing radio link (S-S-RL) on the secondary RAN node side.

In IMT wireless communication systems (such as 4G-LTE and 5G-NR) as shown in FIG. 3, the Radio Access Network (RAN) node may transmit downlink (DL) pilot reference signals such as SSB, CSI-RS etc. The UE receives, measures and processes them so that UE can know the connection quality of radio link (RL) over the air. The UL measurement reports are fed back to the serving RAN node. This may be the communications between the serving RAN node and UE, in order to maintain the communication service continuity. This is an example with single connectivity (SC).

A “UE based DL measurement and UL report” is one example of wireless sensing configured by a RAN. However, there can be more types of wireless sensing between a RAN node and UE or between RAN nodes or between UEs. The RAN and UE can locally measure, detect and sense aspects and objects other than the pilot reference signals for a communication purpose or a sensing purpose. The wireless sensing may be triggered by an upper layer or a third party entity. For example, the UE can sense its local environment (e.g. user gesture, neighbor objects and radio condition) and resource utilization context (e.g. radio/computing/interference status) via its local sensors. This sensing information can be provided as “sensing result info” to its serving RAN node. Based on the wireless sensing, the serving RAN node can know about the UE's environment or any target entity and resource utilization context, and can take adaptive measures to enhance the wireless communication with the UE.

In one example, in the mmWave (e.g. above 6 GHz) communication context, due to bigger path-loss and vulnerable mmWave channel conditions in the high frequency band, the human user's body and hand gestures may impose adverse disadvantages towards UE wireless communications, such as sheltering and interfering with the RL. Previously, the serving RAN node would rely on other reactive mechanisms to boost the quality of RL, which are often not quick or prompt enough, as they rely on the time-consuming activities on UE side. With the integrated wireless communication and sensing system in a dual functional RAN node, the serving RAN node may sense and detect the human user body and hand gestures based on either radar type techniques (with a sensing signal) that is identified much more quickly in advance, so the serving RAN node can take proactive actions to boost the quality of the communication RL.

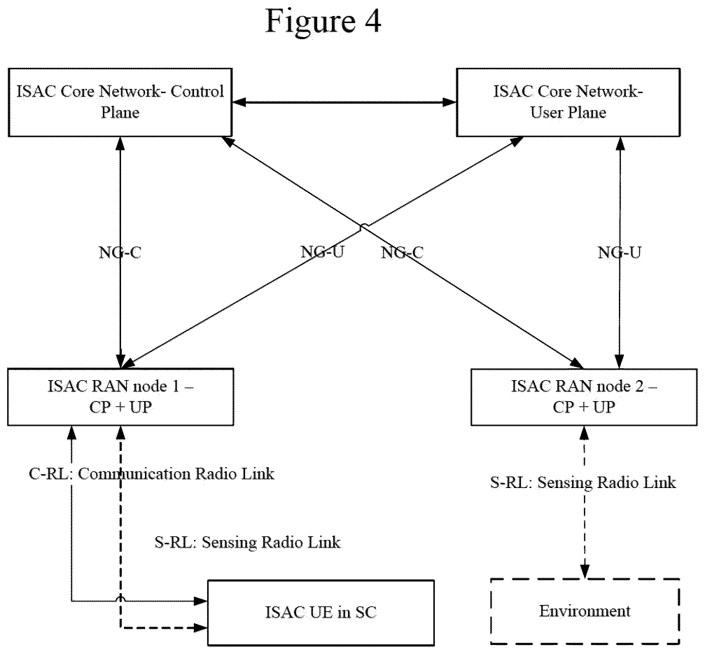

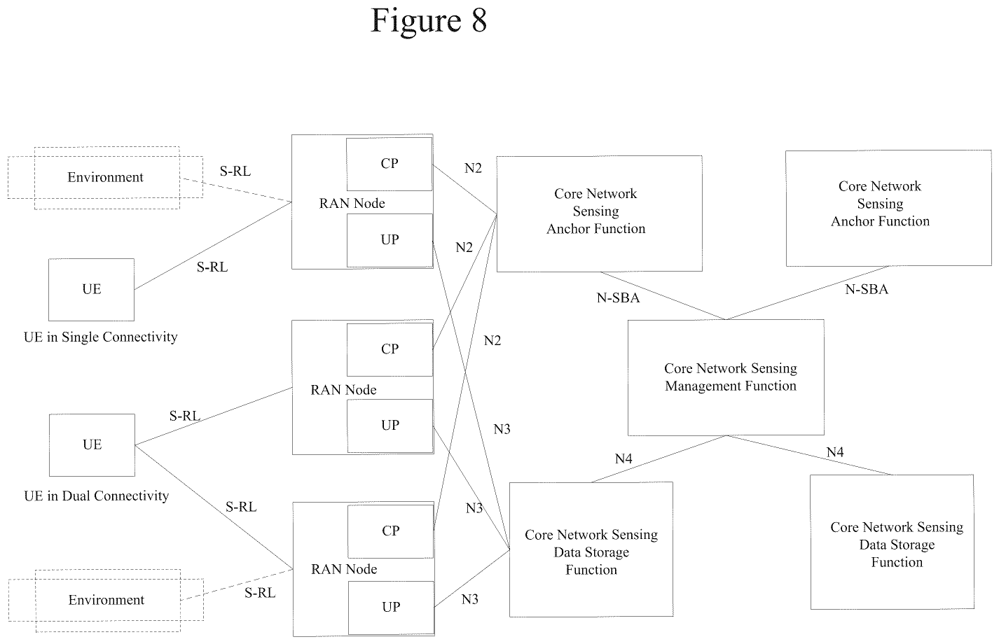

FIG. 4 shows a dual connectivity wireless communication system. Dual connectivity (DC) includes a UE with a secondary communication radio link (S-C-RL) and/or a secondary sensing radio link (S-S-RL). The SC and DC connectivity is further described below, including with respect to FIG. 8. For example, DC operation may include any of the following combinations of X-X-RL:
M-C-RL+M-S-RL;
M-C-RL+S-C-RL;
M-C-RL+S-S-RL;
M-S-RL+S-C-RL;
M-S-RL+S-S-RL; or
S-C-RL+S-S-RL.

In FIG. 4, the UE communicates with the RAN node 1 with both a C-RL and a S-RL. There is a second RAN node that only provides an S-RL towards an environment. The Core Network, RAN node and UE are all ISAC capable in this embodiment. In other words, they are capable of both wireless communication and wireless sensing over the air. The communication radio link is denoted as “C-RL” still serving communication purpose, while the sensing radio link is denoted as “S-RL” which exists as a logic function but also can be physically implemented together with “C-RL.” The ISAC capable RAN node could perform some type of wireless sensing via “S-RL” towards a certain target UE, or it may also perform wireless sensing via “S-RL” towards the environment with assisting UE involvement or without assisting UE involvement.

In some embodiments, there may be communication with a master node and secondary node that are not located together. Multiple RAN nodes of same or different radio access technology (“RAT”) (e.g. eNB, gNB, xNB) can be deployed in the same or different frequency carriers in certain geographic areas, and they can inter-work with each other via a dual connectivity operation to provide joint communication services for the same target UE(s). The system may be referred to as a multi-RAT dual connectivity (“MR-DC”) architecture with non-co-located master node (“MN”) and secondary node (“SN”).

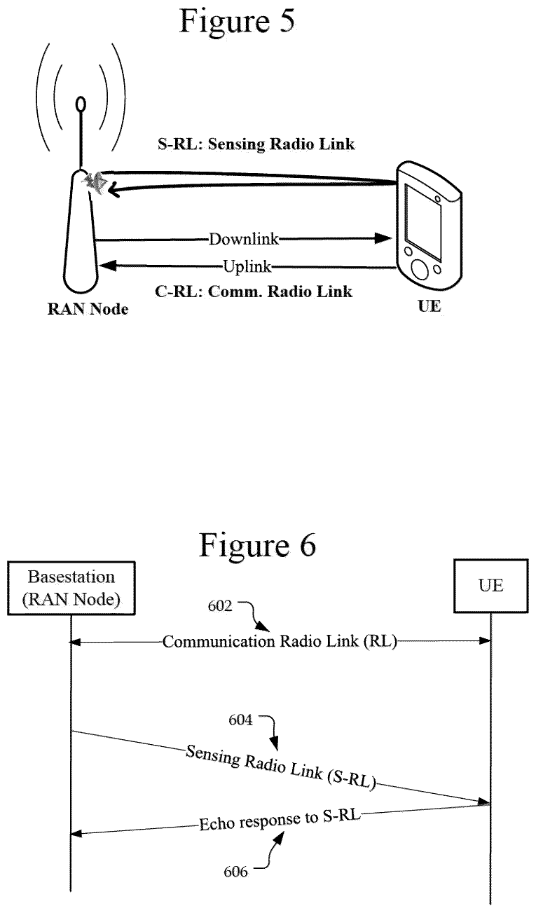

FIG. 5 shows an example radio access network (“RAN”) node that communicates with user equipment (“UE”) through multiple links for a dual function. One of the dual functions is wireless communication and the other is wireless sensing. Wireless communication includes at least one radio link (“C-RL”) for transmitting and receiving (signaling and/or user) data over the air between the RAN node and the UE. Wireless sensing includes a sensing radio link (“S-RL”). The S-RL is setup and used to sense and detect something along a radiation path over the air between the RAN node and the UE. The sensing radio link (“S-RL”) is a logic radio link not used for the purpose of transmitting and receiving (signaling and/or user) data over the air, but is used for the purpose of sensing and detecting something along the radiation path over the air. The dual function RAN node includes a single RAN node which can perform both wireless communication and wireless sensing operations with the target UE. Specifically, FIG. 5 illustrates the dual function RAN node sends a sensing radio link (“S-RL”) to the UE, which then returns a signal (e.g. an echo signal/response) to the RAN node. In addition to the wireless sensing of the S-RL, the dual function RAN node has a communication radio link (“C-RL”). The C-RL is a downlink from the RAN node to the UE and an uplink from the UE to the RAN node. As shown in FIG. 5, the dual function RAN node can setup and maintain both S-RL and C-RL with the target UE simultaneously. For the handling of communication C-RL, it may be the same as legacy systems (e.g. following the specifications of 4G-LTE or 5G-NR).

FIG. 6 shows a communication diagram with a dual function RAN node communication with a communication radio link (“C-RL”) and a sensing radio link (“S-RL”). The RAN node (also referred to as a basestation) establishes a communication C-RL 602 with the UE. In addition, the second function of the RAN node provides an S-RL 604 to the UE. In response to the S-RL 604, the UE provides a response 606. The response 606 may be referred to as an echo signal that transmitted by the UE in direct response to receipt to the S-RL 604 as part of the sensing operation S-RL. S-RL may be a logically separated radio link from the communication C-RL, but physically S-RL may share the same or use different air/radio resources (e.g. time/frequency/space/code etc.) from the communication C-RL's. FIG. 6 shows an example of using different air/radio resources, where the radio signal between RAN node and UE carries either the data information or the sensing related information, but not both in this embodiment.

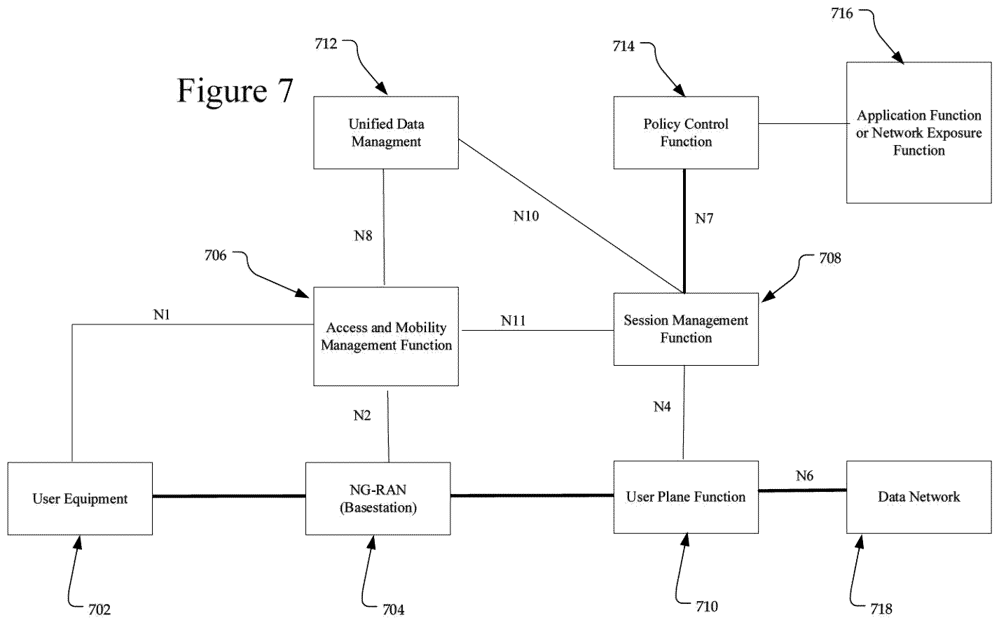

FIG. 7 shows an embodiment of a wireless network system architecture. This architecture is merely one example and there may be more or fewer components for implementing the embodiments described herein. The interconnections or communications between components are identified as N1, N2, N4, N6, N7, N8, N10, and N11, which may be referred to in the description or by other Figures. FIG. 2 illustrated an example user equipment (“UE”) 104. UE 702 is a device accessing a wireless network (e.g. 5GS) and obtaining service via a NG-RAN node or basestation 704. The UE 702 interacts with an Access and Mobility Control Function (“AMF”) 706 of the core network via NAS signaling. FIG. 1 illustrates an example basestation or NG-RAN 102. The NG-RAN node 704 is responsible for the air interface resource scheduling and air interface connection management of the network to which the UE accesses. The AMF 706 includes the following functionalities: Registration management, Connection management, Reachability management and Mobility Management. The AMF 706 also perform the access authentication and access authorization. The AMF 706 is the NAS security termination and relay the session management NAS between the UE 702 and the SMF 708, etc.

The SMF 708 includes the following functionalities: Session Management e.g. Session establishment, modify and release, UE IP address allocation & management (including optional Authorization), Selection and control of uplink function, downlink data notification, etc. The user plane function (“UPF”) 710 includes the following functionalities: Anchor point for Intra-/Inter-RAT mobility, Packet routing & forwarding, Traffic usage reporting, QoS handling for user plane, downlink packet buffering and downlink data notification triggering, etc. The Unified Data Management (“UDM”) 712 manages the subscription profile for the UEs. The subscription includes the data used for mobility management (e.g. restricted area), session management (e.g. QoS profile). The subscription data also includes slice selection parameters, which are used for AMF 706 to select a proper SMF 708. The AMF 706 and SMF 708 get the subscription from the UDM 712. The subscription data may be stored in a Unified Data Repository with the UDM 712, which uses such data upon reception of request from AMF 706 or SMF 708. The Policy Control Function (“PCF”) 714 includes the following functionality: supporting unified policy framework to govern network behavior, providing policy rules to control plane function(s) to enforce the policy rule, and implementing a front end to access subscription information relevant for policy decisions in the User Data Repository. The Network Exposure Function (“NEF”) 716 is deployed optionally for exchanging information with an external third party. In one embodiment, an Application Function (“AF”) 716 may store the application information in the Unified Data Repository via NEF. The UPF 710 communicates with the data network 718.

Access Mobility Function (“AMF”) and Session Management Function (“SMF”) are the control plane entities and User Plane Function (“UPF”) is the user plane entity in new radio (“NR”) or 5GC. The signaling connection between AMF/SMF and MN may be a Next Generation-Control Plane (“NG-C”)/MN interface. The signaling connection between MN and SN may be an Xn-Control Plane (“Xn-C”) interface. The signaling connection between MN and UE may be a Uu-Control Plane (“Uu-C”) RRC interface.

As described below, there may be additional components or entities for a wireless sensing session or sensing signals. FIG. 7 shows signals for communication signals, but there may be an additional sensing session management function 708, which may be referred to as a S-SMF for managing sensing sessions. Likewise, there may be a wireless sensing user plane function 710, which may be referred to as a S-UPF.

The end-to-end (E2E) wireless sensing operation for a sensing service or task may include multiple network nodes (e.g. CN, RAN and UE) that triggers the wireless sensing service. In the embodiments herein, the handling of the wireless sensing service may be coordinated/managed more efficiently for multiple network nodes. FIG. 8 shows an example architecture for an end to end (E2E) wireless sensing operation.

The ISAC RAN node may be referred to as a basestation and may include a control plane (CP) and a user plane (UP). In the example core network (CN) domain, there may be at least the following three function entities for wireless sensing operations:
“Core Network Sensing Anchor Function” may be the anchor point for controlling a sensing session that may involve the ISAC RAN node(s), the UE, and/or the environment.
“Core Network Sensing Management Function”: may be the centralized management point for managing a wireless sensing session, which may include providing the wireless sensing session relevant policy and/or configuration data and/or sensing assistant data, etc,) and include circulating the sensing result data.
“Core Network Sensing Data Storage Function” may be the data storage point for storing the sensing result data reported by the ISAC RAN node(s) and/or UE.

The interface between the “Core Network Sensing Anchor Function” entity and “Core Network Sensing Management Function” entity may be denoted as “N-SBA” (service based architecture like 5GC). A single “Core Network Sensing Management Function” entity may connect with multiple “Core Network Sensing Anchor Function” entities. N-SBA signaling procedure may carry the sensing session related signaling data.

The interface between the “Core Network Sensing Data Storage Function” entity and “Core Network Sensing Management Function” entity is denoted as “N4”. The single “Core Network Sensing Management Function” entity may connect with multiple “Core Network Sensing Data Storage Function” entities. N4 signaling procedure may carry the sensing session related signaling data. N4 data flow procedure may carry the sensing session result data.

The interface between “Core Network Sensing Anchor Function” entity and “ISAC RAN Node-CP Part” may be denoted as “N2”. N2 signaling procedure carries the sensing session related signaling data. The interface between “Core Network Sensing Data Storage Function” entity and “ISAC RAN Node-UP Part” is denoted as “N3.” N3 data flow procedure may carry the sensing session result data.

### Core Network Sensing Management Function

The “Core Network Sensing Management Function” entity may select the target “Core Network Sensing Anchor Function” entity (among multiple options) and trigger a wireless sensing session independently by itself or upon receiving the “Sensing Service Required” message from any other entity. It can coordinate with the selected “Core Network Sensing Anchor Function” entity via N-SBA signaling procedure for managing a wireless sensing session operation.

The “Core Network Sensing Management Function” entity may select the target “Core Network Sensing Data Storage Function” entity (among multiple options) and trigger the retrieval of sensing session result data independently by itself or upon receiving the “Sensing Result Data Retrieval Request” message from any other entity. It can coordinate with the selected “Core Network Sensing Data Storage Function” entity via N4 signaling procedure for retrieving the relevant sensing session result data.

The “Core Network Sensing Management Function” entity may retrieve the relevant sensing session result data via N4 data flow procedure from the target “Core Network Sensing Data Storage Function” entity.

### Core Network Sensing Anchor Function

The “Core Network Sensing Anchor Function” entity can trigger a wireless sensing session independently by itself or upon receiving a “Sensing Service Required” message from any ISAC RAN node or from the UE. It can coordinate with the “Core Network Sensing Management Function” entity via N-SBA signaling procedure for the wireless sensing session operation. Upon obtaining the necessary wireless sensing session policy and/or configuration data and/or sensing assistant data, the “Core Network Sensing Anchor Function” entity may coordinate with the target ISAC RAN node. This may be through the control plane (CP) part via N2 signaling procedure for triggering and controlling a wireless sensing session operation.

### Core Network Sensing Data Storage Function

The “Core Network Sensing Data Storage Function” entity may store sensing session result data upon receiving them reported from ISAC RAN node(s). This may be through the user plane (UP) part via N3 data flow procedure. The “Core Network Sensing Data Storage Function” entity may transfer the sensing session result data via the N4 data flow procedure to the “Core Network Sensing Management Function” entity independently by itself or upon receiving a “Sensing Result Data Retrieval Request” message from the “Core Network Sensing Management Function” entity. The “Core Network Sensing Data Storage Function” entity can also transfer the sensing session result data to the ISAC RAN node(s) through the user plane (UP) part via N3 data flow procedure upon receiving the “Sensing Result Data Transfer Command” from “Core Network Sensing Management Function” entity.

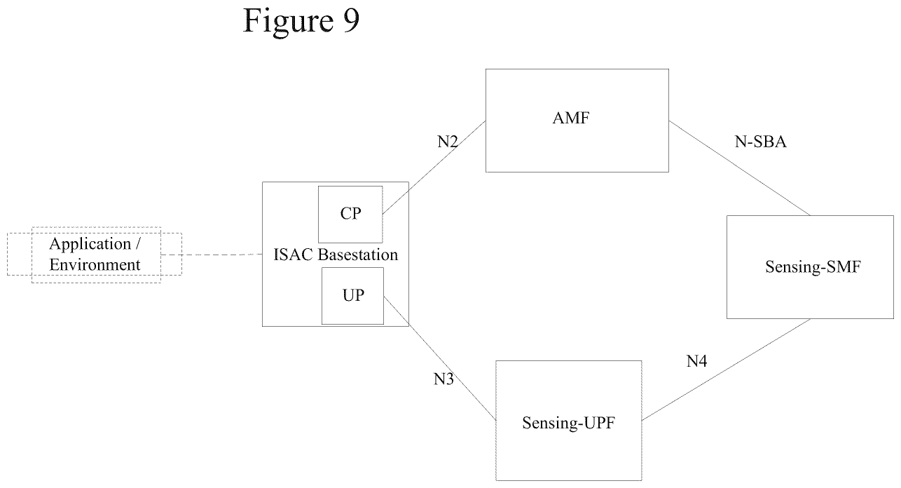

FIG. 9 shows an embodiment of a network system for sensing between multiple network nodes. The ISAC basestation includes a control plane (CP) and a user plane (UP). The network system in FIG. 9 provides for wireless sensing signals and sensing data management/coordination through a sensing SMF (S-SMF) and a sensing UPF (S-UPF). This sensing may be part of a sensing session that the network handles. FIG. 9 illustrates sensing entities that may be different to their communication counterparts (SMF/UPF). These may be additional entities for sensing while SMF/UPF handle communications.

The Access Mobility Function (AMF) may be for communication and/or sensing. Conversely, the S-SMF and the S-UPF may be dedicated or exclusive to a wireless sensing session. The sensing SMF (S-SMF) may correspond with the “Core Network Sensing Management Function” entity. Likewise; the sensing-UPF (S-UPF) may correspond to the “Core Network Sensing Data Storage Function” entity. In some embodiments, the AMF may be enhanced with ISAC capability and corresponds to the “Core Network Sensing Anchor Function” entity. The S-SMF may actively trigger the relevant wireless sensing session towards the proper target AMF entity.

The S-SMF may acquire sensing data for the Application/Environment. In one embodiment, the sensing data may include environment imaging data for a particular area with an imaging resolution and updating period (e.g. 1 m resolution and updating period of 30 seconds in a large sports stadium). In other examples, the sensing data may be from a drone and include drone trajectory information in certain air space to locate an illegally invading drone. The imaging for this example may be imaging resolution 0.1 m and a updating period of 5 seconds. In this example, the drone is much smaller than the sports stadium and may require a finer sensing resolution for the sensing radio link RL. This configuration may be adapted to sensing the drone with finer resolution. In another example, the sensing session may be to acquire vehicle cluster information in an urban area (e.g. for traffic policy steering). This example may have an imaging resolution 0.5 m and updating period 60 seconds.

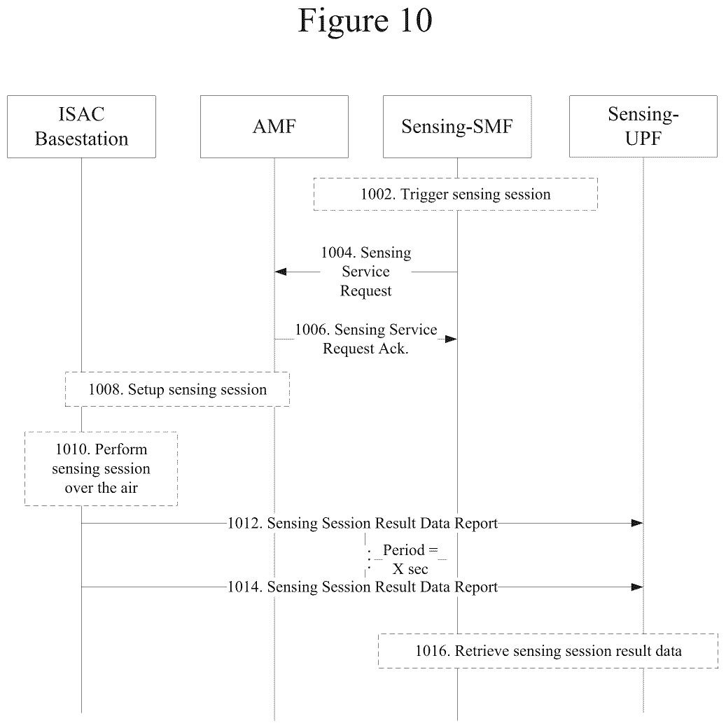

FIG. 10 shows an embodiment of sensing communications between multiple network nodes. In block 1002, the sensing SMF (S-SMF) triggers the sensing session. In one embodiment, the S-SMF coordinates with the selected AMF entity via N-SBA signaling procedure for triggering the desired wireless sensing task. In block 1004, the S-SMF sends the “Sensing Service Request” message to the AMF entity, which provides the sensing session relevant policy and configuration assistant data. For the sports stadium example, the data may include a sensing session id=XXXX, a sensing task type=“target imaging”, a sensing mode=“radar type mechanism”, a sensing target area=“sport stadium”, a sensing operation frequency band=“60 GHz”, a sensing operation bandwidth=“600 MHz”, an imaging resolution=“1 m”, and an imaging updating period=“30 sec.” For the drone example, the data may include a sensing session id=YYYY, a sensing task type=“target object tracing”, a sensing mode=“radar type mechanism”, a sensing target area=“indicated air space area”, a sensing operation frequency band=“200 GHz”, a sensing operation bandwidth=“10 GHz”, an imaging resolution=“0.1 m” and an imaging updating period=“5 sec.” For the vehicle cluster example, the data may include a sensing session id, a sensing task type=“target object(s) detection”, a sensing mode=“radar type mechanism”, a sensing target area=“indicated ground area”, a preferred sensing operation frequency band=“100 GHz”, a preferred sensing operation bandwidth=“5 GHz”, an imaging resolution=“0.5 m” and an imaging updating period=“60 sec.”

Upon receiving the “Sensing Service Request” message, the AMF entity decides whether it can perform the requested wireless sensing task. If admitted, the AMF entity shall prepare the requested wireless sensing operation and reply with the “Sensing Service Request Acknowledge” message in block 1006. If rejected, the AMF entity shall reply with the “Sensing Service Reject” message containing reject cause value rather than the acknowledgment from block 1006. In block 1008, the AMF entity initiates the sensing session setup procedure over N2 interface towards the target ISAC basestation/gNB. The basestation may perform the requested wireless sensing operation over the air in block 1010. This may be based on the received sensing session relevant policy and configuration assistant data.

After obtaining the sensing session result data (e.g. imaging of target sport stadium or drone trajectory information), the ISAC gNB/basestation collects the result data in the UP part and reports them periodically via N3 data flow procedure towards the indicated Sensing-UPF (S-UPF) entity in blocks 1012-1014. The S-UPF entity stores the reported sensing session result data from the ISAC gNB/basestation UP part, associated to the sensing session identification. The S-SMF may retrieve the desired sensing session result data from the S-UPF entity via N4 procedure.

In an alternative embodiment, the AMF from FIG. 9 may be modified for ISAC compatibility for future networks (e.g. 6th generation {6G} network). In one embodiment, this AMF may be referred to as a sensing AMF (S-AMF). In addition, the ISAC basestation is xNB for the updated network. The 6G AMF entity in 6GC with ISAC capability corresponds to the “Core Network Sensing Anchor Function” entity. The modified AMF entity may acquire sensing data and actively triggers the relevant wireless sensing service request towards the S-SMF entity.

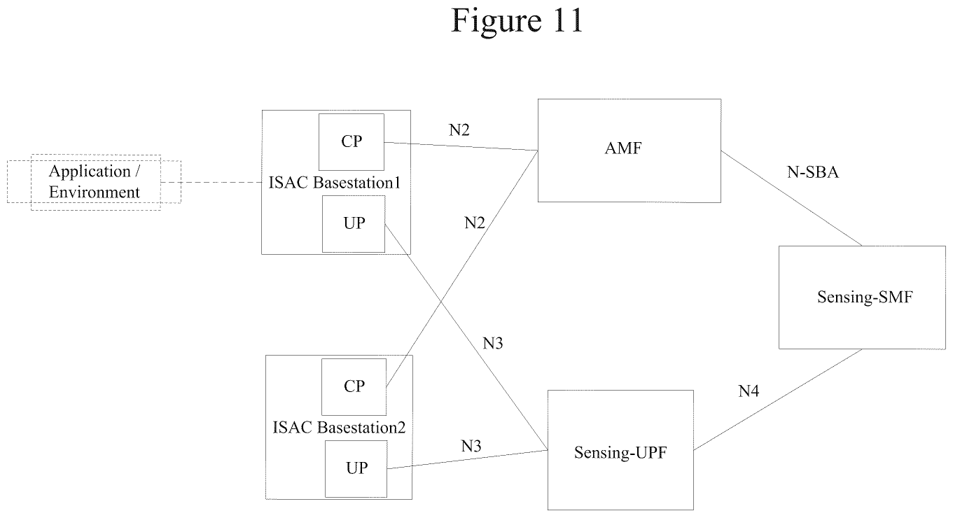

FIG. 11 shows another embodiment of a network system for sensing between multiple network nodes. The ISAC basestations each include a control plane (CP) and a user plane (UP). The network system in FIG. 11 provides for sensing signals and sensing data management/coordination through a sensing SMF (S-SMF), a sensing UPF (S-UPF), and the AMF. This sensing may be part of a sensing session that the network handles.

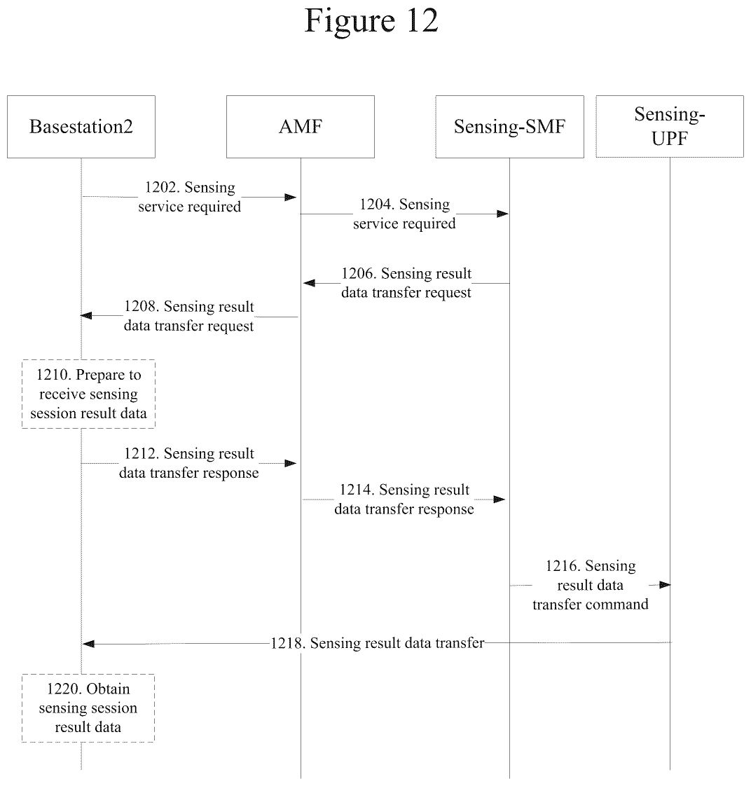

FIG. 11 illustrates two basestations (Basestation1 and Basestation2). These may be xNB nodes. The basestations can initiate/trigger the sensing session, so the sensing SMF or sensing UPF do not need to repeat the sensing. The Sensing-SMF entity corresponds to the “Core Network Sensing Management Function” entity, the Sensing-UPF entity is connected with the Sensing-SMF entity via an N4 interface, and corresponds to the “Core Network Sensing Data Storage Function” entity. The AMF may be a modified AMF that corresponds to the “Core Network Sensing Anchor Function” entity. In this example, the Basestation1 has performed a wireless sensing operation (based on sensing session id) triggered by the Sensing-SMF entity ahead as described above. The Sensing-SMF entity may have already retrieved the desired sensing session result data for the sensing session id from the Sensing-UPF entity. In FIG. 11, the Basestation2 may want to acquire the sensing data. In this example, the Basestation2 may actively trigger a relevant wireless sensing service request to the AMF as shown in FIG. 12.

FIG. 12 shows another embodiment of sensing communications between multiple network nodes. In this example, Basestation2 may initiate the sensing request, and the AMF forwards the request and the sensing data accordingly. Specifically, Basestation2 coordinates with the AMF entity via N2 signaling procedure for triggering the desired wireless sensing task by sending a “Sensing Service Required” message in block 1202 to the AMF entity. The AMF entity coordinates with the Sensing-SMF entity via N-SBA signaling procedure for triggering the desired wireless sensing task by sending the “Sensing Service Required” message in block 1204 to the Sensing-SMF entity. Upon processing the “Sensing Service Required” message, the Sensing-SMF entity determines whether the wireless sensing operation (e.g. based on the sensing session id) has been performed and whether the desired sensing session result data for that session id is available. The Sensing-SMF entity may decide not to perform the desired wireless sensing task again, and sends back the “Sensing Result Data Transfer Request” message in block 1206 to the AMF entity. Upon receiving the “Sensing Result Data Transfer Request” message, the AMF entity forwards the “Sensing Result Data Transfer Request” message in block 1208 to the Basestation2. Upon receiving the “Sensing Result Data Transfer Request” message, the Basestation2 prepares to receive the desired sensing session result data for that particular session id in block 1210. The Basestation2 replies with a “Sensing Result Data Transfer Response” message in block 1212 to the AMF entity. The AMF entity forwards the “Sensing Result Data Transfer Response” message in block 1214 to the Sensing-SMF entity. The Sensing-SMF entity commands the Sensing-UPF entity to transfer the desired sensing session result data of the particular session id via N3 data flow procedure in block 1216 to the Basestation2. In block 1218, the Sensing-UPF entity sends the desired sensing session result data for the particular session id to the Basestation2 with an association for the particular session id. The Basestation2 obtains the sensing session result data in block 1220. It may collect and obtain the desired sensing session result data for the particular session id from the Sensing-UPF entity via N3 data flow procedure.

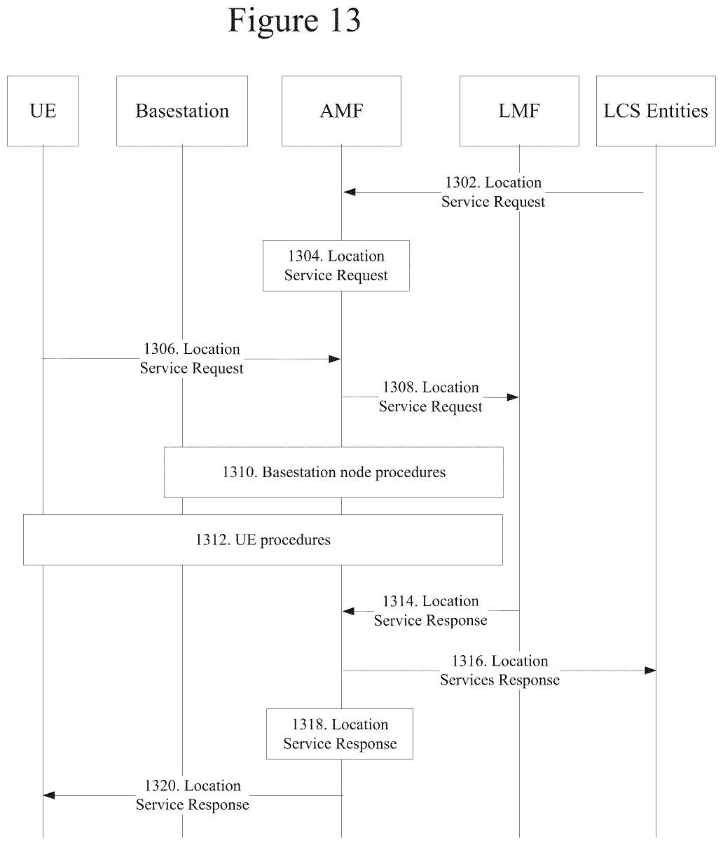

FIG. 13 shows a wireless sensing example with user equipment (UE) positioning. Positioning is one example of wireless sensing. In this example, a UE's position/location is determined. In other embodiments, the sensing may be for something other than a position/location, which is merely one example of a sensing signal. Other wireless sensing examples include radio channel estimation, environment imaging and object detection. This may be based on a radar-type mechanism. In other examples, an ISAC capable UE may perform various wireless sensing for a user's biological indicators based on its local wireless sensors. While, FIG. 13 illustrates UE positioning as one example, any of the other types of wireless sensing operations may be managed and controlled by IMT system in other embodiments. The UE positioning sensing relevant data (e.g. positioning assistant data, configuration data, PRS measurement result data) may be transferred via signaling bearers/connections (e.g. SRB and NGAP). In other wireless sensing embodiments, there may be more types and differing amounts of wireless sensing relevant data that can be transferred and/or stored by the IMT system. As illustrated for UE positioning, there may be a relevant sensing procedure for coordination of wireless sensing operations with multiple network nodes (e.g. LMF, AMF, RAN, UE).

In block 1302, there is a request for location services, which may be from some entity in the 5GC (e.g. GMLC). As mentioned, this example is specific to location, positioning, or location/position services, but this is just one example of sensing data. In another embodiment, the serving AMF for a target UE may determine the need for a location service in block 1304 (e.g. to locate the UE for an emergency call). In another embodiment, the UE requests a location service (e.g. positioning or delivery of assistance data) to the serving AMF at the NAS level in block 1306.

In block 1308, the AMF transfers the location service request to an LMF. In block 1310, the LMF instigates location procedures with the serving and possibly neighboring basestations to obtain positioning measurements or assistance data. In an alternative embodiment, the LMF instigates location procedures with the UE in block 1312 to obtain a location estimate or positioning measurements or to transfer location assistance data to the UE. The LMF provides a location service response to the AMF in block 1314 and includes any needed results (e.g. success or failure indication and, if requested and obtained, a location estimate for the UE). In response to block 1302, the AMF returns a location service response in block 1316 (response from block 1314) to the AMF and includes any needed results (e.g. a location estimate for the UE). In response to block 1304, the AMF uses the location service response in block 1318 (using the response received in block 1314) to assist the service that triggered this in block 1304 (e.g. may provide a location estimate associated with an emergency call to a GMLC). In response to block 1306, the AMF returns a location service response in block 1320 to the UE and includes any needed results (e.g. a location estimate for the UE).

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method for wireless sensing comprising:
triggering, by a Core Network Session Sensing Management Function (S-SMF), a wireless sensing session for sensing purposes;
coordinating, by the S-SMF with at least one other network node, via signaling procedures; and
managing, by the S-SMF, operation of the wireless sensing session based on the coordinating.

2. (canceled)

3. The method of claim 1, wherein
the triggering is initiated independently by the S-SMF or upon receiving a command for “Sensing Service Required” from another node or entity; and
the coordinating is with a Core Network Sensing Anchor Function (AMF) having wireless sensing contexts and a Core Network Sensing Data Storage Function (S-UPF) having wireless sensing session result data.

4. (canceled)

5. The method of claim 1, further comprising:
selecting a target Core Network Sensing Anchor Function before the triggering.

6. The method of claim 1, further comprising:
triggering a retrieval of wireless sensing session result data by the Core Network S-SMF independently or upon receiving the a “Sensing Result Data Retrieval Request” command from another node or entity.

7. (canceled)

8. The method of claim 6, wherein the wireless sensing session result data comprises a sensing result data associated with the wireless sensing session performed by a basestation and/or a user equipment (UE).

9. The method of claim 6, further comprising:
storing the sensing session result data by a Core Network Sensing Data Storage Function” entity (S-UPF).

10. The method of claim 1, wherein the wireless sensing session comprises different wireless sensing types having at least one of a target positioning determination, a radio channel estimation, an environment imaging or object detection based on radar type sensing, and/or biological indicators.

11. The method of claim 10, wherein the wireless sensing session comprises functions performed by local wireless sensors in a basestation and/or a user equipment (UE).

12. (canceled)

13. (canceled)

14. A wireless sensing system comprising:
a wireless sensing session management function (S-SMF) for managing a wireless sensing session and providing policies, configuration data, or sensing assistant data related to the wireless sensing session; and
a session management function (SMF) for providing communication session related policies and configuration data, wherein the S-SMF is independent and decoupled from the SMF.

15. The wireless sensing system of claim 14, further comprising:
a user equipment (UE); and
a basestation between the UE and an Access and Mobility Management Function (AMF), the S-SMF, or the SMF.

16. The wireless sensing system of claim 15, wherein the basestation generates wireless sensing signals subject to policies, configuration data, or sensing assistant data provided by S-SMF, and wherein the wireless sensing signals are for the UE, a target entity, or environment.

17. (canceled)

18. The wireless sensing system of claim 15, wherein
the managing of the wireless sensing session by the S-SMF comprises a retrieval of wireless sensing session result data, the retrieval being performed independently or upon receiving a “Sensing Result Data Retrieval Request” command from another node or entity.

19. (canceled)

20. The system of claim 18, wherein the sensing session result data comprises data associated with the wireless sensing session performed by the basestation and/or the UE.

21. The wireless sensing system of claim 14, wherein the wireless sensing session managed by the S-SME comprises different wireless sensing types having at least one of a target positioning determination, a radio channel estimation, an environment imaging or object detection based on a radar-type sensing, and/or biological indicators.

22. A wireless sensing system comprising:
a Sensing Anchor Function (AMF) configured for controlling a wireless sensing session;
a Sensing Session Management Function (S-SMF) configured for managing the wireless sensing session; and
a Sensing Data Storage Function (S-UPF) configured for storing wireless sensing session result data from the wireless sensing session.

23. The wireless sensing system of claim 22, wherein the managing the wireless sensing session by the S-SMF further comprises:
providing a wireless sensing session relevant policy;
providing a wireless sensing session relevant configuration data and/or assistant data; and
circulating the wireless sensing session result data with another node or entity.

24. The wireless sensing system of claim 23, wherein the wireless sensing session result data is reported by a basestation, a user equipment (UE), and/or is circulated from the S-UPF.

25. The wireless sensing system of claim 23, wherein the Sensing Session Management Function (S-SMF) comprises a centralized management point in the system.

26. (canceled)

27. The wireless sensing system of claim 22, wherein the wireless sensing session result data stored by the S-UPF comprises sensing result data associated with the wireless sensing session performed by a basestation and/or a user equipment (UE).

28. The wireless sensing system of claim 22, wherein the wireless sensing session managed by the S-SMF comprises different wireless sensing types having at least one of a target positioning determination, a radio channel estimation, an environment imaging or object detection based on radar-type sensing, and/or biological indicators.
